(19) United States
(12) Patent Application Publication
(10) Pub. No.: US 2025/0148360 A1
(43) Pub. Date: May 8, 2025

(54) SYSTEM AND METHOD FOR PRE-LOADING CONTENT IN A WEB ENVIRONMENT

(71) Applicant: American Express Travel Related Services Company, Inc., New York, NY (US)

(72) Inventors: Rick BALLMAN, Phoenix, AZ (US); Shanmuga KRISHNAMURTHY, Phoenix, AZ (US)

(73) Assignee: American Express Travel Related Services Company, Inc., New York, NY (US)

(21) Appl. No.: 18/504,771

(22) Filed: Nov. 8, 2023

(51) Int. Cl. G06N 20/00; H04L 67/50

(52) U.S. Cl. CPC G06N 20/00; H04L 67/535

(57) ABSTRACT

Disclosed herein are system, method, and computer program product embodiments for providing predictive interface generation. As a user interacts with a user interface, information relating to the user, including the user activity within the user interface and/or historical data relating to the user is provided to a machine learning model. The machine learning model uses artificial intelligence and the received user data to predict a likely next action that the user will take. In some instances, multiple next actions are determined, each with a corresponding confidence score. A most likely subset of those results are then provided to a preloading system that retrieves the data from a database that is needed to provide the response to those actions. This data is then preloaded in memory for immediate access, in the event that one of the predicted actions is actually carried out by the user.

### BACKGROUND

### Field

This field is generally related to software development and more specifically to reducing latency in a web environment.

### Background

Large web environments provide a dynamic interface with which a user can interact in order to acquire services or other information from a company or individual. Typically, when a user takes an action in a web interface, the web interface responds to that action, retrieving the necessary data to generate a response to the user's action, and then generating the necessary display. This action takes time that appears to the user like a loading of the requested content.

### BRIEF SUMMARY

Disclosed herein are system, apparatus, device, method and/or computer program product embodiments, and/or combinations and sub-combinations thereof, for reducing latency in a web interface.

Software applications, specifically those provided in a web interface, often have several different actions they can perform and/or webpages or other interfaces that they can display based on the user actions within the web interface. Specifically, when a user clicks on a link, a new web page may be generated or data can be displayed in a separate window, or a separate widget may be generated. In each of these situations, the web interface backend must determine the action being taken by the user, retrieve the necessary data from memory or a separate server to satisfy the user request, load the retrieved data into cache, and then process the cached data into the requested webpage or other element that was requested. This can occur both on a webpage or other interface being provided directly to the user, or to an agent web page or interface of an agent that is associated with the company that is assisting the user. This can take significant time, and will appear to the user like lag or latency.

The present application provides solutions to this problem. According to the present application, a machine learning model is trained to predict a user's next action based on the user's history and their current behavior. Based on the prediction, the data required to generate the user's most likely actions can be retrieved from memory and/or the server and pre-loaded into cache before the user ever actually signals that the predicted action will be taken. Then, once the user signals the intent to pursue a particular action, the data will be ready for immediate use. As such, the largest part of the perceived latency (e.g., the retrieval of data from the backed) will be erased.

In this manner, a dynamic webpage is provided and appears in a streamlined manner with minimal or low latency. These and other advantages will be apparent from the following detailed description.

### BRIEF DESCRIPTION OF THE DRAWINGS

The accompanying drawings are incorporated herein and form a part of the specification.

FIG. 1 illustrates a block diagram of a prediction environment, according to some embodiments.

FIG. 2 illustrates a block diagram of a prediction environment, according to some embodiments.

FIG. 3 illustrates a block diagram of an exemplary prediction system, according to some embodiments.

FIG. 4 illustrates a block diagram of an exemplary web interface backend, according to some embodiments.

FIG. 5 illustrates a process flow diagram of an exemplary method for predictive preloading, according to some embodiments.

FIG. 6 illustrates a flowchart diagram of an exemplary method for predicting a next user action, according to some embodiments.

FIG. 7 illustrates a flowchart diagram of an exemplary method for generating a web interface, according to some embodiments.

FIG. 8 illustrates a block diagram of an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof, for reducing latency in a web interface.

Software applications, specifically those provided in a web interface, often have several different actions they can perform and/or webpages or other interfaces that they can display based on the user actions within the web interface. Specifically, when a user clicks on a link, a new web page may be generated or data can be displayed in a separate window, or a separate widget may be generated. In each of these situations, the web interface backend must determine the action being taken by the user, retrieve the necessary data from memory or a separate server to satisfy the user request, load the retrieved data into cache, and then process the cached data into the requested webpage or other element that was requested. This can occur both on a webpage or other interface being provided directly to the user, or to an agent web page or interface of an agent that is associated with the company that is assisting the user. This can take significant time, and will appear to the user like lag or latency. In other words, the user may experience a delay between their action and any updates or changes to the webpage, interface, or an agent in response to a detected user's action.

The present application provides solutions to this problem. According to the present application, a machine learning model is trained to predict a user's next action based on the user's history and their current behavior. In some aspects, the machine learning model identifies one or more actions corresponding to web interface interactions. This may include a series of web interface interactions. This series of web interface interactions may be considered a user journey. In some aspects, the machine learning model may identify one or more user journeys from among a plurality or user journeys. Based on the predicted action and/or series of actions, the data required to generate the user's most likely actions can be retrieved from memory and/or the server and pre-loaded into cache before the user ever actually signals that the predicted action will be taken. Then, once the user signals the intent to pursue a particular action, the data will be ready for immediate use. As such, the largest part of the perceived latency (e.g., the retrieval of data from the backed) will be erased.

In this manner, a dynamic webpage is provided and appears in a streamlined manner with minimal or low latency. These and other advantages will be apparent from the following detailed description.

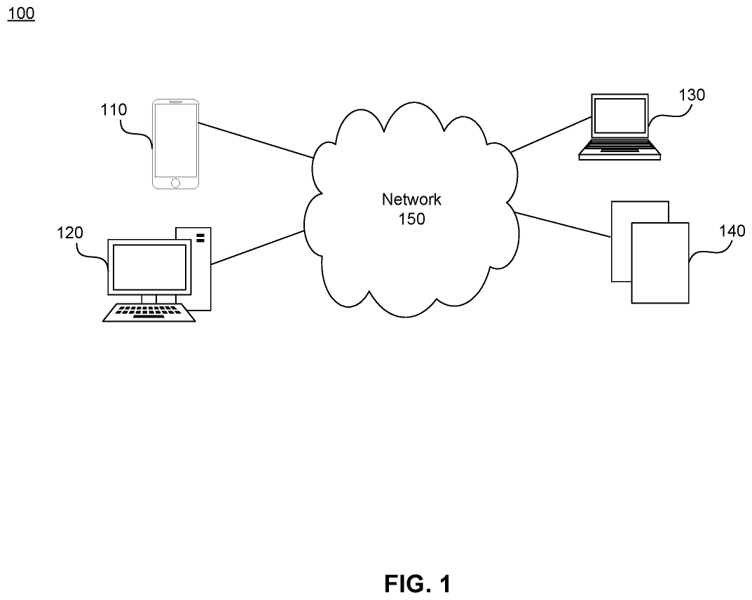

FIG. 1 illustrates a block diagram of a prediction environment 100, according to some embodiments. As shown in FIG. 1, the environment 100 includes a user device 110 and/or a user terminal 120 connected to an agent terminal 130 and one or more servers 140 via a network 150.

In an embodiment, the user device 110 may include a cellular telephone, a personal digital assistant, a personal computer, or other computing device capable of making a call, or communicating over the network 150 with agent terminal 130. In an embodiment, the user device 110 communicates using any known digital communication standard via one or more cellular telephone networks, such as 5G, 4G, etc.

In an embodiment, user terminal 120 includes a personal computer, laptop computer, or any other device capable of accessing the one or more servers 140 and/or the agent terminal 130 via the network 150. In an embodiment, the user terminal 120 communicates via the Internet using any known digital communication protocol, including but not limited to known packet-based protocols, such as hypertext transfer protocol (HTTP).

In an embodiment, the agent terminal 130 is located at, or is associated with, the servicing website's owner/operator company. In embodiments, the agent terminal 130 is used by an agent of the company used for purposes of assisting the needs of customers.

In an embodiment, the servers 140 are a corporation's web servers configured to generate and display a web interface to a user and/or the agent and to interact with company data servers in support therefor. The servers 140 may be any suitable type of server capable of retrieving necessary data, and generating the agent or user interfaces.

In operation, a user may call a customer service number, enter into an online customer service chat, or access the company's website in an attempt to resolve or obtain assistance with some issue. The user may carry out these operations using either the user device 110 or the user terminal 120. In the event that the user engages an agent, the user will be connected via the network 150 to an agent operating at agent terminal 130. If, on the other hand, the user merely accesses the website directly, then the user will be connected with the servers 140 via the network 150. In some embodiments, the user may perform both functions separately or simultaneously (such as calling an agent while viewing the website).

When the user contacts the company through any of these channels, the web server 140 performs predictive analysis based on the user's history, interactions, and/or current behavior in order to predict the user's needs and likely next action. Based on this prediction, a web server from among the servers 140 obtains the necessary data to fulfill that likely next action from a data server included among the servers 140 and preloads this data into cache, so that it is ready for use. Once the user's next action is confirmed, the relevant data loaded into cache is used to generate an updated interface either for the agent terminal 130 or the webpage, depending on the user's mode of communication. If the predictions were incorrect, and the cached data is not needed, then the correct data is retrieved from the data server and the appropriate response interface is generated based on the newly-obtained data. These and other aspects will be described in further detail below.

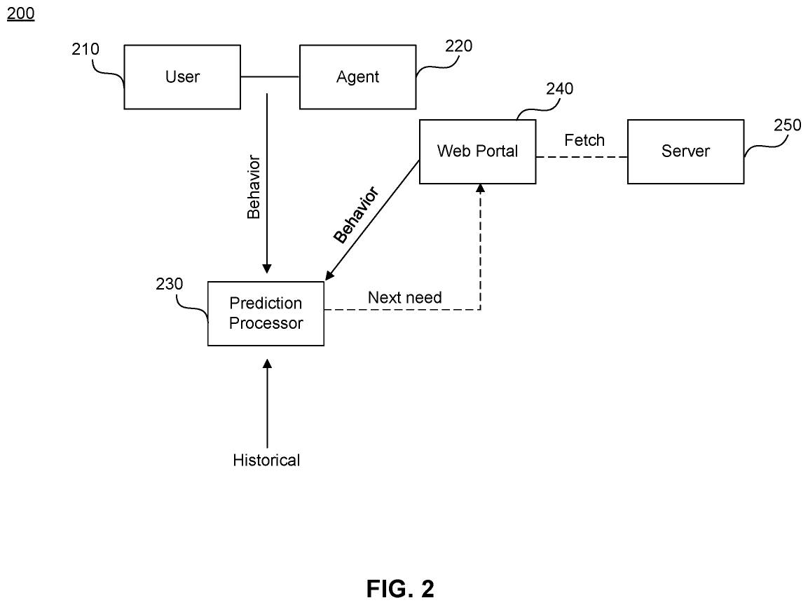

FIG. 2 illustrates a block diagram of a prediction environment 200, according to some embodiments. As shown in FIG. 2, the environment 200 includes a user 210, an agent 220, a prediction processor 230, a web portal 240, and a server 250. In an embodiment, the user 210 communicates with the agent 220 for service assistance. As discussed above, the user may be communicating with the agent via either a user device 110 or a user terminal 120. In another embodiment, the user communicates directly with the web portal 240, such as through a web page, for example.

In an embodiment, the prediction processor 230 uses available data relating to the user 210 in order to predict the user's next action. In embodiments, such data may include the user's behavioral data, with respect to one or both of the agent 220 or the web portal 240, and historical data relating to the user 210. In some embodiments, the prediction processor 230 may further employ external or environmental data to assist in its prediction.

In operation, when a user 210 first access the service, whether in communication with the agent 220 or the web portal 240, the prediction processor 230 makes an initial next action prediction. At this time, because there is typically no or limited behavioral data of the user 210 in the current session, the prediction processor 230 may obtain and primarily rely on the user's historical data or external data. For example, if a particular user 210 is known to access the web page on the 15^{th} of every month in order to pay their bill, and the current session takes place on or near the 15^{th}, then the prediction processor 230, using this historical data, will make an initial next action prediction that the user 210 is accessing the web page to pay their bill. In this manner, historical data may include data corresponding to past user interactions with an agent 220 and/or web portal 240. Similarly, if the prediction processor 230 is aware of a major data breach involving banking customers in London, England, and a user 210 calling the agent 220 is calling from or near London, then the prediction processor 230 will make an initial next action prediction of viewing recent transactions and/or card replacement. This may be considered external or environmental data, which may correspond to data gathered by prediction processor 230 that is independent from user interaction data. For example, this may include data related to news, events, occurrences, and/or data that may impact several users.

Once the user 210 begins to interact with the web portal 240 or the agent 220, the prediction processor 230 can take the user's behavioral data into account. Such behavioral data may include data corresponding to actions taken by the user during a web session and/or a customer service interaction session. This data may include real-time data. For example, the behavioral data may include the user's spoken words, movement or actions of a computer mouse within the web page supported by the web portal 240, search commands entered by the user, the user's stress level detected on a call or chat with the agent 220, among others. Using this behavioral data, the prediction processor 230 repeatedly predicts the user's likely next action. For example, using speech processing, the prediction processor 230 may determine that the user 210 inquired about a new account. In this case, the prediction processor 230 may make a next action prediction of account generation. Likewise, if the prediction processor 230 is provided with data from a call between the user 210 and the agent 220 that the user is very stressed, then the prediction processor 230 may predict viewing recent transactions as the likely next action. For example, behavioral data collected may include audio tones, pace of speech, textual data corresponding to the words spoken, and/or other data corresponding to the call. In embodiments, the prediction processor 230 calculates the predicted next action using a machine-learning model, as described in further detail below.

Once the prediction processor 230 receives the data used to generate a prediction, and calculates the predicted next action, then the prediction processor 230 provides the conclusion of this analysis to the web portal 240. In preparation for this predicted next action coming to fruition, the web portal 240 retrieves from the server 250 the data used to provide the predicted service. For example, the predicted service may be to generate and provide a particular webpage. In embodiments, the retrieved data may include the HTML data used to generate the webpage, database entries used to fulfill a potential request, and/or forms, transcripts, or other data used to support the agent 220 in responding to the user's predicted next action. The web portal 240 pre-loads this data into cache, where it remains at the ready until either the action is confirmed, or some predetermined action occurs that renders this data no longer needed. In embodiments, the predetermined action may include an amount of elapsed time passing, the execution of a different action, the end of the user session, and/or other action that may void the predicted next action.

The web portal 240 generates the interface being provided to the agent 220 and/or the user 210. If the prediction was accurate, then the web portal 240 uses the pre-loaded data. However, if the user 210 takes an action that uses new data, the web portal 240 performs another fetch from the server 250 to obtain the data used to respond to the action.

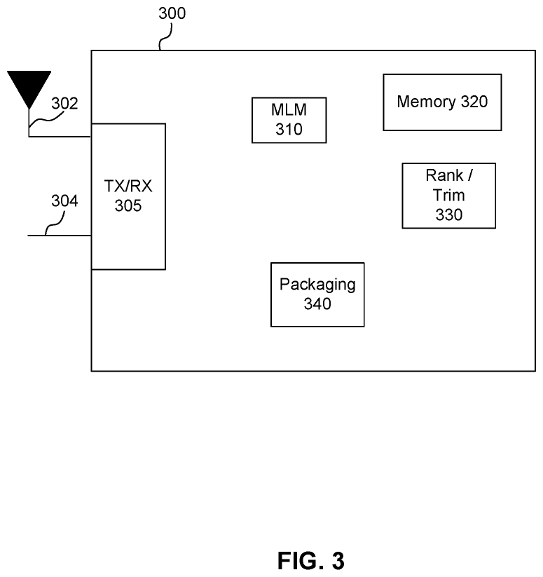

FIG. 3 illustrates a block diagram of an exemplary prediction system 300, according to some embodiments. As shown in FIG. 3, the prediction system 300 includes a transceiver 305, a machine learning model 310, a memory 320, a rank/trim block 330, and a packaging block 340.

In an embodiment, the transceiver 305 is configured to receive data needed to execute a next action prediction. In embodiments, the transceiver 305 receives the data via an antenna 302 over a wireless interface or via a wired connection 304. In embodiments, the transceiver communicates using any known communication standard. The transceiver 305 initially receives identification data of the user and/or historical information of the user. As the user's session progresses, the transceiver receives behavioral data of the user. This information is provided to the machine learning model 310.

The machine learning model 310 may use a machine learning algorithm, including but not limited to deep learning, artificial intelligence, statistical classification, neural network, linear regression, and others. The machine learning model 310 receives the user data from the transceiver 305 and performs predictive analysis thereon to detect a user's likely next action. For example, if a particular user is known to access the web page on the 15^{th} of every month in order to pay their bill, and the current session takes place on or near the 15^{th}, then the prediction processor, using this historical data, will make an initial next action prediction that the user is accessing the web page to pay their bill. Similarly, if the prediction processor is aware of a major data breach involving banking customers in London, England, and a user calling the agent is calling from or near London, then the prediction processor will make an initial next action prediction of viewing recent transactions and/or card replacement.

The machine learning model 310 accesses the memory 320 for relevant mappings of user behavior or history to different actions. In an embodiment, the machine learning model 310 does not identify a single likely next action, but rather multiple next actions. In order to differentiate these likely next actions from each other, the machine learning model 310 also generates a likelihood, score, certainty, or other ranking with respect to each determined likely next action. These likely next actions and their respective scores are then provided to the rank/trim block 330.

The rank/trim block 330 identifies which of the likely next actions should be sent to the web portal. In different embodiments, this can be performed in a number of different ways. In a first embodiment, the rank/trim block 330 can identify the likely next actions above a certain certainty threshold. In another embodiment, the rank/trim block 330 can identify a predetermined number of the likely next actions with the highest certainty among those calculated. For example, in embodiments, the rank/trim block 330 can select the top 1, the top 3, or the top 5 choices. This may depend on the expenditure of computing resources. Specifically, preloading the data for several potential next actions may have diminishing returns and may require consecutively more and more processing power and cache space. The rank/trim block 330 may be configured to balance these factors when identifying the likely next actions to send to the web portal.

Once the rank/trim block 330 has selected the likely next actions to be sent to the web portal, the rank/trim 330 sends these results to the packaging block 340, which packages the selected actions into a notification message. In an embodiment, the notification message includes an identification of the user and/or the selected likely next actions. The packaging block 340 causes the transceiver 305 to transmit the notification message to the web portal for fetching and/or preloading data corresponding to the selected likely next actions, as will be described in further detail below.

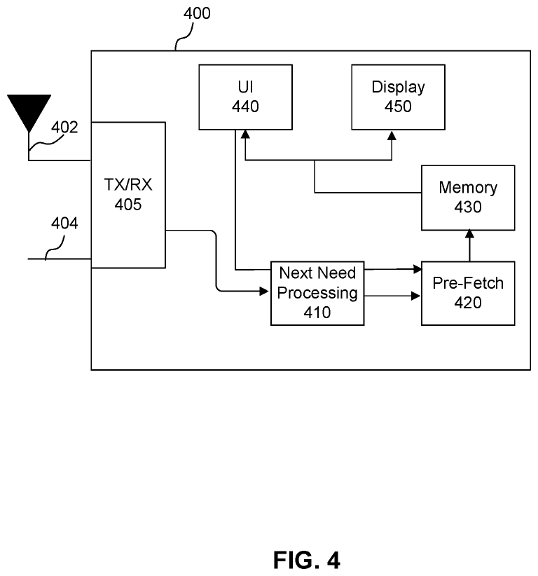

FIG. 4 illustrates a block diagram of an exemplary web portal 400, according to some embodiments. As shown in FIG. 4, the web portal includes a transceiver 405, a next need processing block 410, a pre-fetch block 420, a memory 430, a user interface 440, and a display 450.

The web portal 400 generates a user interface at user interface 440 and causes the output of the user interface at display 450. In this manner, the web portal 400 is responsible for providing the user of the web site or agent site with the visual and interactive tools to be able to effectively use the web site.

The web portal 400 receives the notification message from the prediction system 300 at the transceiver 405. In embodiments, the notification message can be received via antenna 402 over a wireless communication interface or over wired connection 404, which may be a wired communication interface. The notification message includes the user identification and/or the likely next actions associated with that user. The notification message is provided to the next need processing block 410.

The next need processing block 410 receives the notification message from the transceiver 405. The next need processing block 410 identifies the user of the current session from the user identification included within the notification message. The next need processing block 410 then identifies the likely next needs included within the message. This information is forwarded to the pre-fetch block 420.

In an embodiment, the pre-fetch block 420 retrieves the data from a backend server, such as a web server or a data server, in order to fulfill each of the different likely next actions included in the notification message. In another embodiment, the pre-fetch block 420 may also have decision-making authority over the number of next actions to pre-load. For example, the pre-fetch block 420 may be aware that the cache is already nearing capacity, or that processing resources are low. In these, or other instances, the pre-fetch block 420 may alter the number of likely next actions to pre-load.

Once the pre-fetch block 420 obtains the data from the backend server(s), it pre-loads this data into the memory 430. In an embodiment, memory 430 is a cache memory. In operation, the UI 440 detects an actual next action from the user. If the next action has been pre-loaded into the memory 430, then the UI 440 obtains the relevant data to satisfy the next action from the memory 430 and generates the user interface corresponding thereto. This is then output via display 450. On the other hand, if the actual next action has not been pre-loaded into memory 430, then the UI 440 notifies the pre-fetch block 420 to obtain and load the appropriate data from the backend server so as to allow the UI 440 to adequately satisfy the next action.

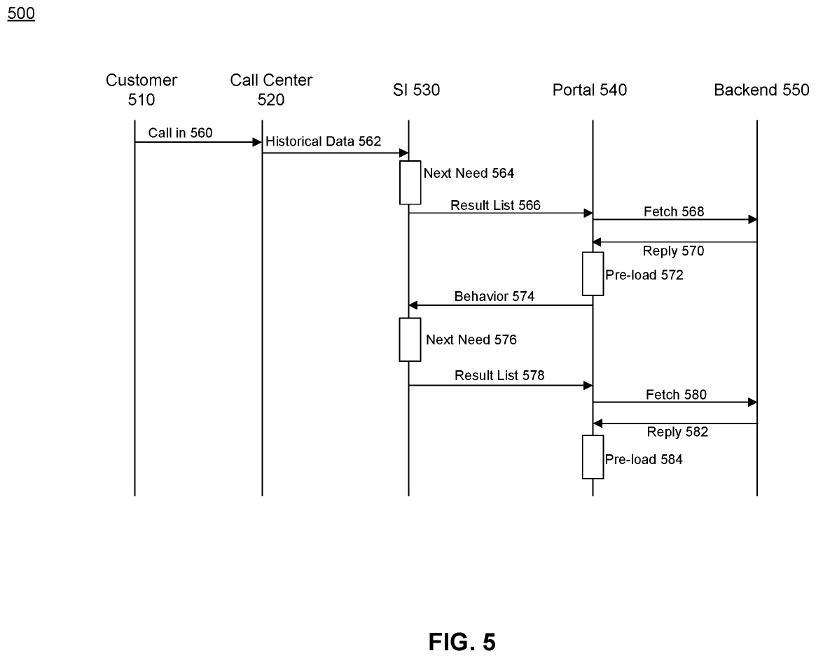

FIG. 5 illustrates a process flow diagram of an exemplary method 500 for predictive preloading, according to some embodiments. As shown in FIG. 5, the process 500 is carried out between a customer 510, a call center 520, a service intelligence 530, a portal 540, and a backend 550. In embodiments, the call center 520 is an exemplary embodiment of agent 220, the service intelligence 530 is an exemplary embodiment of prediction system 230, and the portal 540 is an exemplary embodiment of web portal 240.

The process 500 begins with the customer 510 calling into the call center 520 at 560. Although described herein as a call, it should be understood that the customer 510 can contact the call center 520, in a variety of other ways, including over a chat interface. Upon initiation of the user session, the call center 520 sends historical data associated with the user to the service intelligence 530 at 562. In embodiments, the service intelligence 530 also receives external or environmental data relating to the customer 510.

The service intelligence 530 performs an initial likely next action calculation 564 based on the received data. In an embodiment, the initial likely next action calculation 564 produces a plurality of results. The results may be compiled into a result list which may indicate predicted next actions. The service intelligence 530 transmits this result list to the portal 540 at 566. At 566, the portal 540 receives the result list and transmits a fetch request to the backend 550 at 568. This fetch request is used to obtain the data used to fulfill the likely next actions included in the result list. At 570, the backend 550 transmits a reply to the portal 540 that includes the requested data.

The portal 540 receives the reply data from the backend 550 and performs a pre-load operation to load the received data into memory at 572. Once pre-loaded, the data remains available for use by the portal 540 until the actual action by the user is detected.

From this point on within the user session, operation of the process continues largely as already described, except that behavioral data of the user can also be accounted for. Specifically, the portal 540 identifies the user's behavior and forwards the behavior data to the service intelligence 530 at 574. The service intelligence 530 receives the behavioral data of the user and performs a likely next action prediction at 576. As with the previous calculation, this may produce a list of likely next actions. The service intelligence 530 transmits the result list to the portal 540 at 578. The portal 540 receives the result list and transmits a fetch request at 580 to the backend 550 requesting the data needed to satisfy the actions included within the result list.

In response, at 582, the backend 550 transmits a reply message to the portal 540 that includes the requested data. The portal 540 receives this data and pre-loads it into local memory at 584. The data remains in memory until the actual next action by the user is received. The process substantially repeats steps 574-584 for the remainder of the user session.

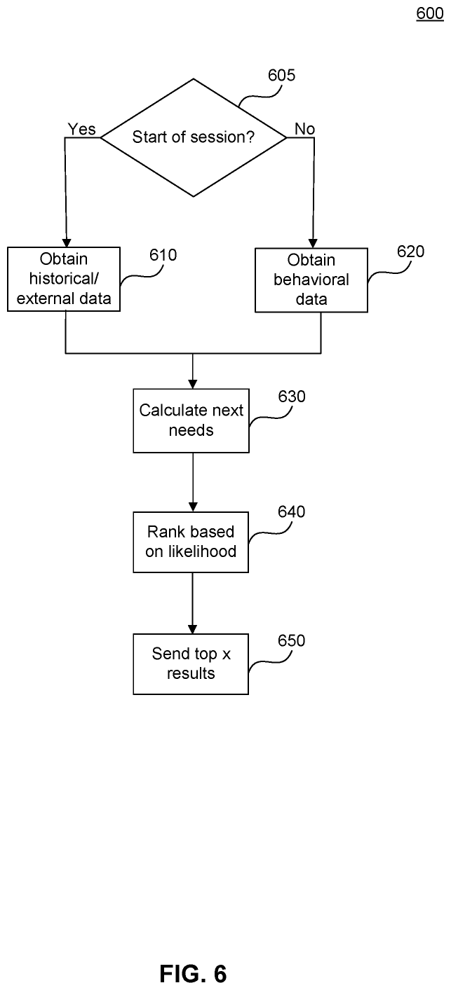

FIG. 6 illustrates a flowchart diagram of an exemplary method 600 for predicting a next user action, according to some embodiments. As shown in FIG. 6, the method begins at step 605, where a determination is made regarding whether the prediction is being made at the start of the user session (e.g., prior to any significant interaction with the user). For example, this may correspond to a particular phase of the user session. If it is determined that this is the start of the session (605—Yes), then the method proceeds to step 610, where historical and/or environmental data relating to the user is obtained. This may correspond to an initial phase of the user session. If, on the other hand, this is not the start of the user session (605—No), then behavioral data relating the user is obtained in step 620. This may correspond to an ongoing phase of the user session. The behavioral data may include user interactions with a web portal and/or an agent that have occurred during the session. The behavioral, historical, and/or environmental data may correspond to user activity data received during the user session.

In step 630, using the data obtained in either of steps 610 or 620, the user's likely next action is predicted. In an embodiment, this prediction is performed using a machine learning model and/or artificial intelligence. For example, the machine learning model may use the received data to estimate a likely action to be taken by the user among a plurality of known or available actions. In an embodiment, each of these different actions is associated with a confidence score or other indicator of the likelihood that it is chosen. To perform this prediction, the machine learning model may have been previously trained using training data including behavioral data, historical data, and/or external data. This data may have been linked to one or more corresponding actions. Training of the machine learning model may include adjusting the weights of the model according to the training data to generate a confidence score corresponding to one or more actions. In this manner, the machine learning model may have been trained to identify one or more web interface interactions corresponding to user activity data. When received user activity data or new parameters are applied at step 630, the machine learning model may produce one or more confidence scores corresponding to one or more available actions or web interface interactions.

In step 640, the likely next actions are ranked according to their respective confidence scores. Then, in step 650, a subset of the ranked actions are forwarded to a web portal. In an embodiment, the subset of actions are selected based on those actions whose confidence scores exceed a predetermined threshold. The selection of the number of actions may also include selecting a predetermined number of the top-ranked actions and/or may also utilize other suitable methods.

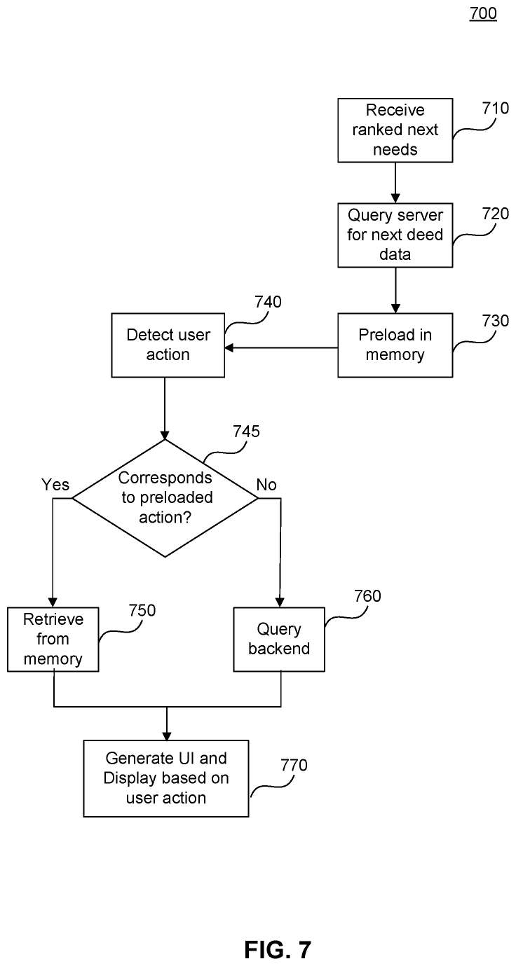

FIG. 7 illustrates a flowchart diagram of an exemplary method 700 for generating a web interface, according to some embodiments. As shown in FIG. 7, the method 700 begins by a web portal receiving the ranked list of likely next actions in step 710. In an embodiment, this list includes a plurality of likely next actions ranked according to their respective confidences that they will be carried out.

In step 720, the web portal queries a backend server based on the received list. Specifically, the web portal transmits a request to a backend server, such as a web server or a data server, for the data used to fulfill each of the actions included in the received list. The web portal may fetch web interface data corresponding to each of the actions.

In response, the web portal receives the requested data from the backend server. Then, in step 730, the web portal preloads the received data into local memory. In an embodiment, the local memory is a cache memory used by the web portal for generating the user interface and/or display. The preloaded data may be web interface data. This preloading occurs prior to the user performing an actual next action and/or prior to the detection of the actual next action.

In step 740, the web portal identifies an actual user next action based on the actions of the user within the web interface. In embodiments, this action may involve the user clicking on a link, making a verbal request or inquiry, typing a search command, etc.

In step 745, a determination is made regarding whether the actual action taken by the user corresponds to one of the predicted and preloaded actions stored in the memory in the earlier step 730. If the action has been preloaded (745—Yes), then the data used to perform that action is retrieved from the local memory in step 750. If, on the other hand, the user's action does not correspond with one of the preloaded actions (745—No), then the web portal queries the backend again in step 760 for the necessary data to fulfill the requested action.

In step 770, the web portal generates the user interface and/or display based on the user action and the retrieved data corresponding thereto.

It should be understood that unless a method step relies on an earlier method step for completion, the order of the various method steps may be rearranged according to different embodiments and implementations. Additionally, there may be many modifications available for the methods of FIGS. 5-7. For example, the methods may further includes the various notified modules modifying their behavior and/or appearance in response to the received notifications.

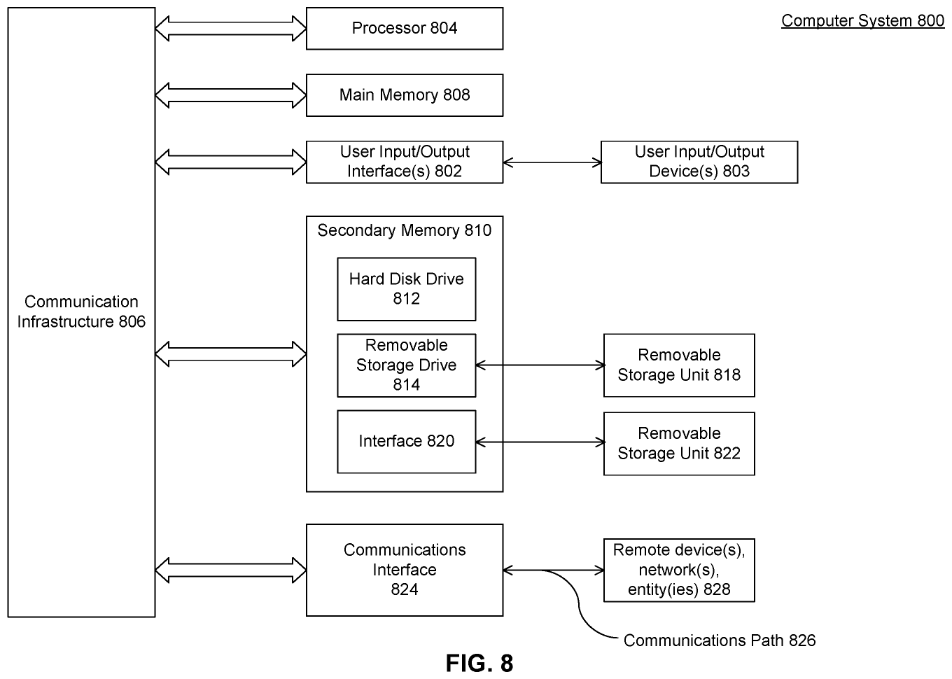

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 706 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A web prediction system, comprising:
a memory that stores data associated with a user;
an interface configured to interact with the user during a user session; and
one or more processors communicatively coupled to the memory and the interface, wherein the one or more processors are configured to:
receive, during the user session, user activity data from the interface;
predict a likely next action that the user will take by applying the received user activity data to a machine learning model trained to identify one or more web interface interactions corresponding to user activity data;
fetch web interface data corresponding to the likely next action; and
load the fetched web interface data into the memory prior to detecting an actual next action of the user.

2. The web prediction system of claim 1, wherein the user activity data includes behavioral data of the user.

3. The web prediction system of claim 1, wherein the user activity data includes at least one of historical and environmental data relating to the user.

4. The web prediction system of claim 1, wherein the one or more processors are configured to predict a plurality of likely next actions, each ranked according to a confidence score.

5. The web prediction system of claim 1, wherein the user activity data includes one of behavioral data or historical data relating to the user depending on a phase of the user session.

6. The web prediction system of claim 1, wherein the user activity includes the historical data during an initial phase of the user session, and includes the behavioral data during an ongoing phase of the user session.

7. The web prediction system of claim 1, wherein the one or more processors are further configured to:
detect the actual next action of the user;
determine whether the detected actual next action of the user corresponds to a likely next action loaded into the memory; and
generate the interface or perform a new fetch depending on the determining.

8. A method for predictive preloading of a web environment during a user session, comprising:
receiving, during the user session, user activity data of the user;
predicting a likely next action that the user will take within the web environment by applying the received user activity data to a machine learning model trained to identify one or more web interface interactions corresponding to the user activity data;
fetching web interface data corresponding to the likely next action; and
loading the fetched web interface data into memory prior to detecting an actual next action of the user.

9. The method of claim 8, wherein the user activity data includes behavioral data of the user.

10. The method of claim 8, wherein the user activity data includes at least one of historical and environmental data of the user.

11. The method of claim 8, further comprising predicting a plurality of likely next actions, each ranked according to a confidence score.

12. The method of claim 8, wherein the user activity data includes one of behavioral data or historical data relating to the user depending on a phase of the user session.

13. The method of claim 8, wherein the user activity data includes the historical data during an initial phase of the user session, and includes the behavioral data during an ongoing phase of the user session.

14. The method of claim 8, further comprising:
detecting the actual next action of the user;
determining whether the detected actual next action of the user corresponds to a likely next action loaded into the memory; and
generating the interface or performing a new fetch depending on the determining.

15. A non-transitory computer-readable storage medium storing instructions thereon that when read executed by one or more processors cause the one or more processors to execute functions, comprising:
receiving a user identity of a user;
retrieving historical and environmental data associated with the user based on the user identity;
calculating an initial next action prediction by applying the historical and environmental data to a machine learning model trained to identify one or more web interface interactions corresponding to historical and environmental data;
fetching initial web interface data corresponding to the initial next action;
preloading the fetched initial web interface data into memory prior to detecting an actual next action of the user;
receiving user activity data of the user;
calculating a subsequent next action prediction based on the user activity data;
fetching subsequent data needed to carry out the subsequent next action; and
preloading the fetched subsequent data into the memory prior to determining an actual next action of the user.

16. The non-transitory computer-readable storage medium of claim 15, wherein the user activity data includes behavioral data of the user.

17. The non-transitory computer-readable storage medium of claim 15, wherein each of the initial next action prediction and the subsequent next action prediction predict a plurality of likely next actions, each ranked according to a confidence score.

18. The non-transitory computer-readable storage medium of claim 15, wherein the initial next action prediction or the subsequent next action is performed based on a phase of a user session.

19. The non-transitory computer-readable storage medium of claim 18, wherein the initial next action prediction is performed during an initial phase of the user session and wherein the subsequent next action prediction is performed during an ongoing phase of the user session.

20. The non-transitory computer-readable storage medium of claim 15, wherein the functions further comprise:
detecting the actual next action of the user;
determining that the actual next action corresponds to the predicted next action; and
generating a user interface from the data preloaded into the memory.
